(19) United States
(12) Patent Application Publication
(10) Pub. No.: US 2006/0289459 A1
(43) Pub. Date: Dec. 28, 2006

(54) Method for cooking in a pan

(75) Inventors: Helen Schmidt, Eichstetten (DE); Peter Wiedemann, Klosterlechfeld (DE); Gerd Funk, Landsberg (DE)

Correspondence Address: MARSHALL, GERSTEIN & BORUN LLP, 233 S. WACKER DRIVE, SUITE 6300, SEARS TOWER, CHICAGO, IL, 60606, US

(73) Assignees: RATIONAL AG, Landsberg/Lech (DE); FRIMA S.A., Wittenheim-Cedex (DE)

(21) Appl. No.: 11/408,368

(22) Filed: Apr. 21, 2006

(30) Foreign Application Priority Data
Apr. 25, 2005 (EP) 05 290 910.8

(51) Int. Cl. H05B 1/02

(52) U.S. Cl. 219/497

(57) ABSTRACT

A cooking method for a cooking device with at least one cooking container, such as in the form of a pan or similar, which can be filled at least partly with a fluid cooking medium, especially water or milk, so that the cooking product can be cooked, especially boiled or poached in the cooking medium, including the following steps: selecting semi-automatic cooking or fully automatic cooking by an operator, selecting a cooking product and/or of a cooking process by an operator, automatically filling a first cooking container with a cooking medium in an amount determined as a function of the selected cooking product and/or selected cooking process, automatically heating the cooking medium in the first cooking container to a temperature determined as a function of the selected cooking product and/or the selected cooking process, automatically introducing the cooking product into the heated cooking medium, automatically cooking the cooking product in the heated cooking medium as a function of the selected cooking product and/or the selected cooking process, and automatically removing the cooked cooking product from the cooking medium.

### BACKGROUND OF THE INVENTION

1. Field of the Invention

The invention concerns a cooking method for a cooking device with at least one first cooking container such as in the form of a pan or the like, which can be filled at least partially with a fluid cooking medium, especially water or milk, so that a cooking product can be cooked (e.g., boiled or poached) in the cooking medium.

2. Related Technology

Such cooking methods are well-known such as, for example, from DE 200 23 460 U1, in which a cooking device is disclosed, and which describes the cooking of a cooking product in a liquid cooking medium in a heatable pan with utilization of detected core temperature values of the cooking product.

A known cooking device with a pan-like first cooking container, which is partially filled with liquid cooking medium and into which a cooking product can be introduced in a second cooking container, for example in the form of a cooking basket, for the purpose of cooking, is disclosed in DE 102 24 465 B4, for example.

Cooking devices can also be constructed in a modular manner, and, for example, include a number of pans representing first cooking containers, for example as disclosed in DE 203 10 602 U1.

Known cooking devices are fundamentally suitable and there is a demand for cooking methods for such known cooking devices, especially for the automation of cooking, so that even untrained operators can produce high-quality foods. This is of great importance, especially for large kitchens in which in a small space a large number of foods must be prepared simultaneously and cost-effectively under great time pressure.

### GENERAL DESCRIPTION OF THE INVENTION

The invention therefore further develops the generic cooking method in such a way that it provides at least semi-automatic boiling or poaching of a cooking product reproducibly with high quality.

The method of the invention includes the following steps:
Selecting semi-automatic cooking or fully automatic cooking by an operator,
Selecting a cooking product and/or of a cooking process by an operator,
Automatically filling a first cooking container with a cooking medium in an amount determined as a function of the selected cooking product and/or selected cooking process,
Automatically heating the cooking medium in the first cooking container to a temperature determined as a function of the selected cooking product and/or the selected cooking process,
Automatically introducing the cooking product into the heated cooking medium,
Automatically cooking the cooking product in the heated cooking medium as a function of the selected cooking product and/or the selected cooking process, and
Automatically removing of the cooked cooking product from the cooking medium.

The selection of a cooking product and/or a cooking process may include the selection of one or more type(s) of cooking product, a cooking product charge, a cooking product size, a cooking product final condition, or a cooking operation type, performed through a display and operating device of the cooking device.

It is preferred that the selection of a type of cooking product includes the selection of at least one of eggs, vegetables, rice, pastas (especially noodles), meat (including sausage or fish), preferably in a first menu level provided on the display and operating device and/or the selection of a cooking product charge includes the selection of the load, especially of a second cooking container, such as in the form of a cooking basket or similar, with cooking product, preferably in a second menu level provided on the display and operating device, and/or the selection of the cooking product size includes the selection of a mean cooking product size, preferably in the second menu level provided on the display and operating device, and/or the selection of a cooking product end condition includes the selection of an internal cooking product end condition, especially determined by the cooking time and/or the core temperature of the cooking product, and/or an external cooking product condition, preferably provided in the second menu level on the display and operating device, and/or the selection of a type of cooking operation includes the selection between boiling or poaching, preferably in the second menu level provided on the display and operating device.

A cooking method according to the invention can also include an automatic request for loading of a part of the cooking device which can be moved relative to the first cooking container, with a cooking product, via the display and operating device of the cooking device, especially after reaching a certain temperature in the cooking medium.

Moreover, according to the invention, an automatic request can be provided for unloading the part of the cooking device that can be moved relative to the cooking container from the cooking product, via the display and operating device of the cooking device, especially after the elapse of a certain cooking time determined as a function of the selected cooking product and/or the selected cooking process and/or after reaching a certain core temperature in the cooking product determined as a function of the selected cooking product and/or the selected cooking process.

Furthermore, the movable part of the cooking device, which is preferably in working connection with a cover of the first cooking container with which the first cooking container can be at least partially closed, can be moved automatically for intermittent introduction of the cooking product into the heated cooking medium.

It is also preferred that at least one second cooking container, such as in the form of a cooking basket or similar, which can be loaded with cooking product and connected with the cover, is moved into the first cooking container and out of it, preferably with the aid of a lifting and lowering device.

With the invention a cooking method is also proposed for boiling eggs which includes automatic request for quenching the eggs, preferably with the aid of a hand-spray of the cooking device and/or through the display and operating device of the cooking device, between automatic removal of the cooked eggs from the cooking medium and the automatic request for unloading the eggs.

Furthermore, each automatic request may be offered in at least one third menu level of the display and operating device.

Furthermore, the display and operating device may include at least one touch screen, preferably a plurality of touch screens, that is/are in interaction with a control or regulating device of the cooking device, especially for providing a menu level as a function of at least one selection step carried out by an operator for offering at least one request and/or for providing at least one item of information about the status of the cooking method as well as for receiving at least one command in at least one selection step for guiding the cooking method.

The cooking method, preferably after the automatic removal of the cooked cooking product from the cooking medium, can be stored and/or programmed especially through the display and operating device.

The cooking method can also be interrupted and/or explained through a help text, especially through the display and operating device.

The invention thus is based on the surprising finding that a cooking method, in which the cooking product is to be boiled or poached in a fluid cooking medium, especially in water or milk, can be further automated by the fact that of not only having an operator in communication with the cooking device that performs the cooking method, but of the cooking device also performing cooking steps automatically. Hereby the cooking device can automatically pour cooking medium in a necessary amount into a first cooking container can heat the said cooking medium automatically to a required temperature can introduce the cooking product automatically into the heated cooking medium, can cook the cooking product automatically completely, and finally can remove the cooked cooking product again from the cooking medium in order to avoid overcooking.

### BRIEF DESCRIPTION OF THE DRAWINGS

Other characteristics and advantages of the invention follow from the description given below, in which a practical example of the invention is explained with the aid of schematic drawings as example. The following are shown:

FIG. 1 is a display and operating device of a cooking device for performing a cooking method according to the invention in a first menu level,

FIG. 2 shows the display and operating device of FIG. 1 in a second menu level; and

FIGS. 3-10 show the display and operating device of FIG. 1 in a third menu level at different sequential points in time

### DETAILED DESCRIPTION

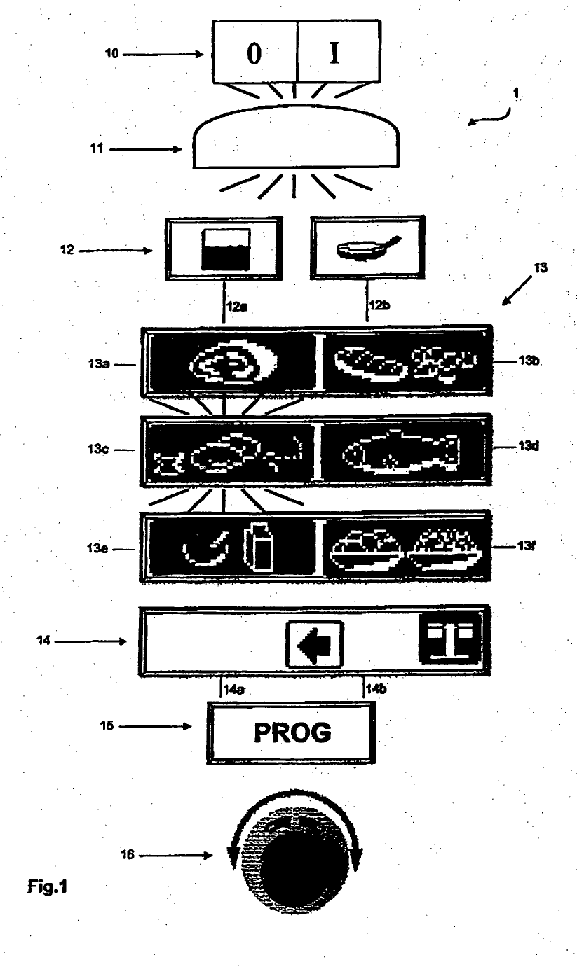

As can be seen from FIG. 1, a cooking device, for example, as it is known from DE 203 10 602 U1, additionally comprises, for example, two pan-like first cooking containers (not shown), which are introduced on both sides on a column-like carrier (not shown), with a display and operating device 1 on the carrier. The display and operating device 1 includes an on/off switch 10, a switching element 11 for activating a semi-automatic or fully-automatic cooking method, a cooking operation type selection element 12, a cooking product selection field 13, a communication element 14, a programming element 15 and a selection and confirmation element 16. The cooking operation type selection element 12 includes in turn two switching elements 12a, 12b, whereby the type of operation “boiling” or “poaching” can be activated by operating the first switching element 12a, the operation type “roasting” by activating the second switching element 12b, and the type of operation “frying” by activating both switching elements 12a and 12b. The cooking product selection field 13 in turn includes six cooking product selection elements 13a to 13f The communication element 14 finally includes an information element 14a and a pan selection element 14b.

FIG. 1 indicates by arrows in the region of switching element 11, that a semi-automatic or fully automatic cooking method was chosen by an operator, namely for cooking eggs as a cooking product, as is indicated by arrows in the region of the cooking product selection element 13c. In addition, it can be seen from the pan selection element 14b that the display and operating device 1 is assigned to the pan located to the left of the column-like carrier, whereby activation of the pan selection element 14b would represent the display and operating device 1 for the pan arranged to the right of the column-like carrier.

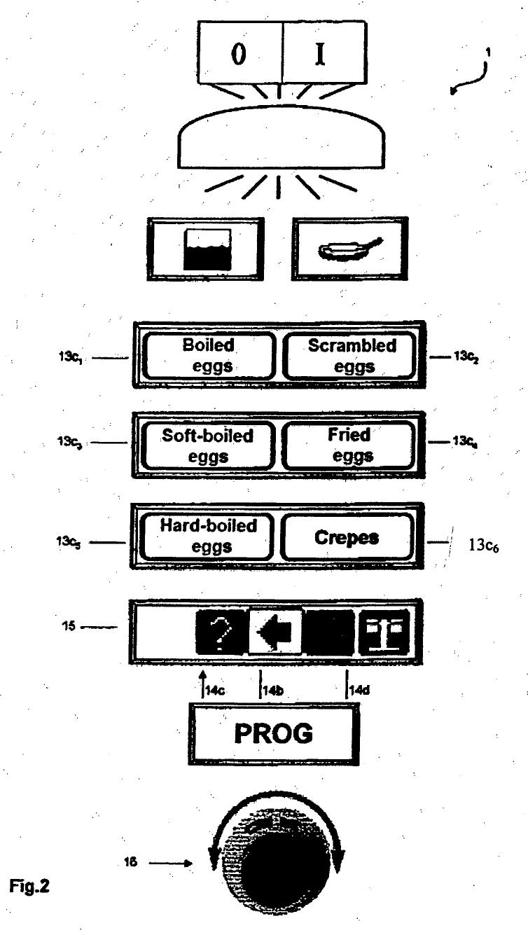

In the first menu level of the display and operating device 1 shown in FIG. 1, one has thus selected from the multiple number of cooking methods stored in the cooking device an at least semi-automatic cooking of eggs. For changing the menu level for this selection, one can either wait for a certain period of time or the selection and operating element 16 can be activated. This leads to the display of a second menu level according to FIG. 2.

As can be seen from FIG. 2, there is a possibility in the second menu level of selecting a cooking process for eggs via the cooking selection elements 13c₁-13c₆. For example, in the second menu level, the cooking selection element 13c₁ can be activated, that is, a type of cooking of eggs can be selected so that the finished eggs will be still very soft inside. In case further information is desired regarding the second menu level, a help text recall element 14c in the area of the communication element 14 can be activated. Naturally, the cooking method can also be interrupted by activating an interruption element 14d in the area of the communication element 14. However, if a selection has been made, then in a third menu level it can be changed by activating the selection and operation element 16.

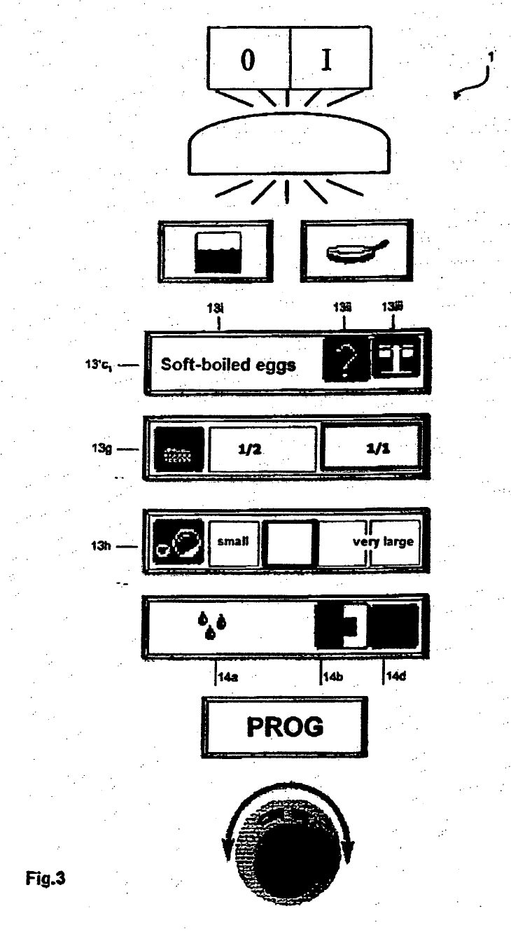

FIG. 3 shows this third menu level of the display and operating device 1 in which, in the area of the cooking product selection field 13, now the selection of a cooking product charge via a cooking product charge selection element 13g and the selection of a cooking product size via a cooking product size selection element 13h is possible. For example, in FIG. 3 as an example, full loading of a cooking basket was selected as cooking product charge and relatively small eggs were selected as cooking product size, unless the cancel element 14d was activated. In addition, the cooking product selection element 13c₁ is now divided into three regions, comprising a cooking product display 13i, a help text recall element 13ii and a cooking device display 13iii.

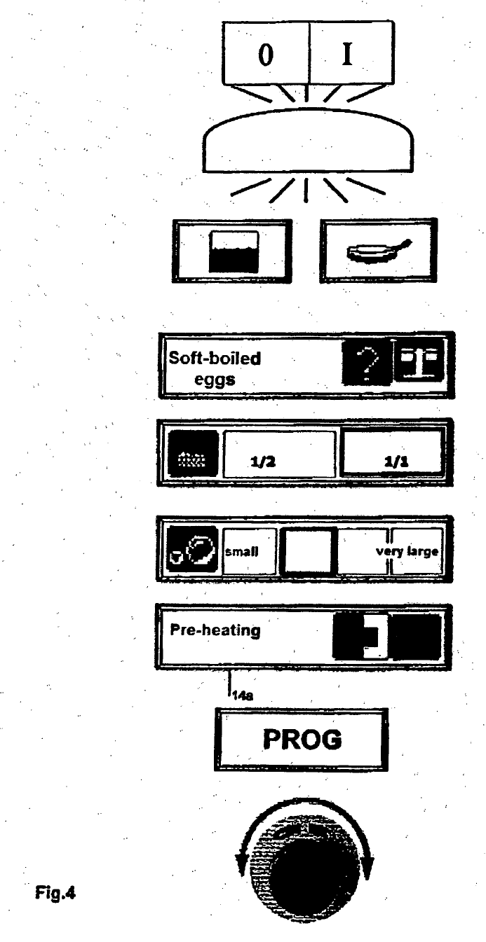

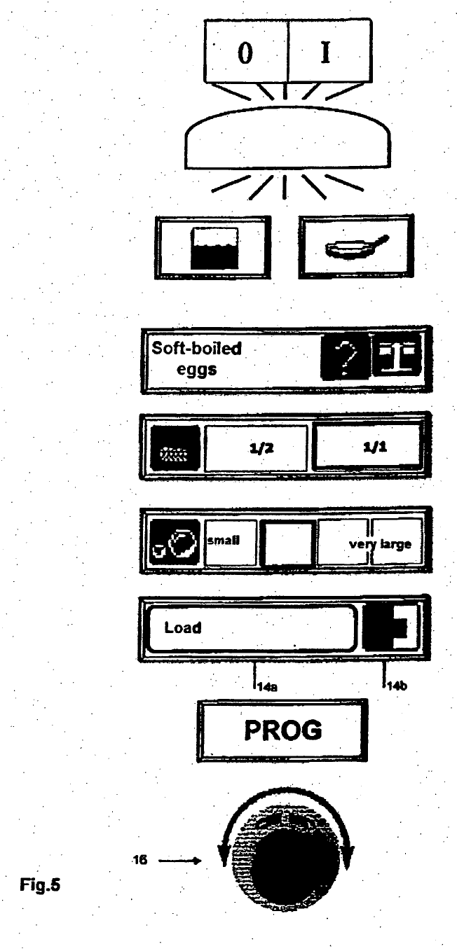

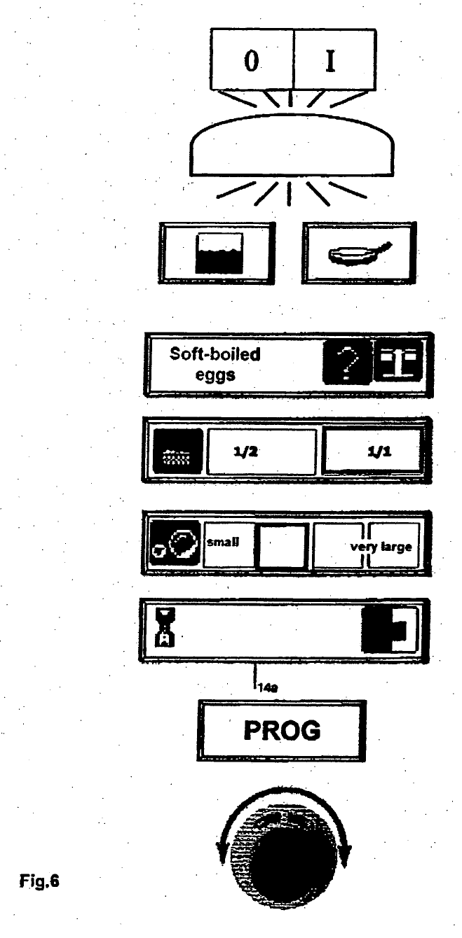

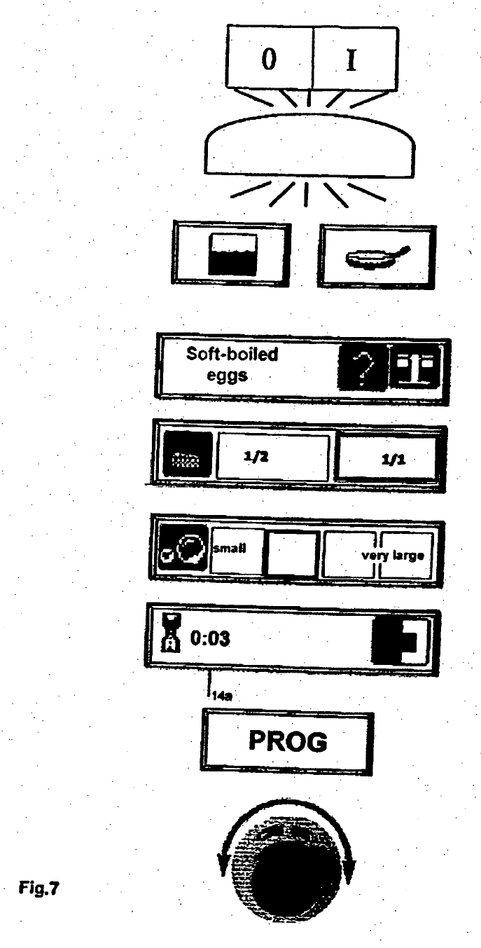

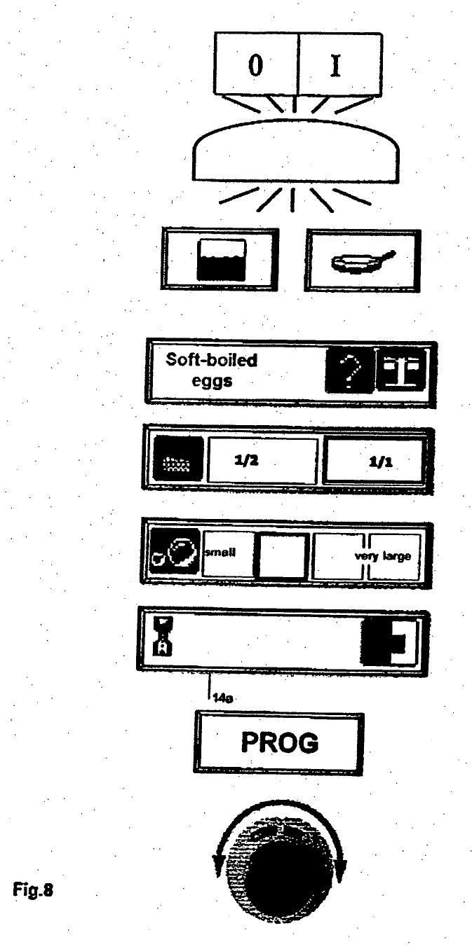

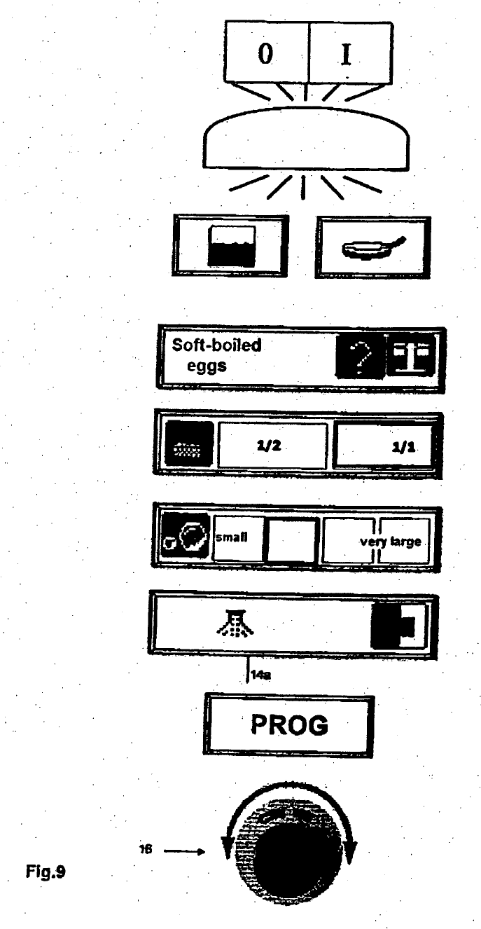

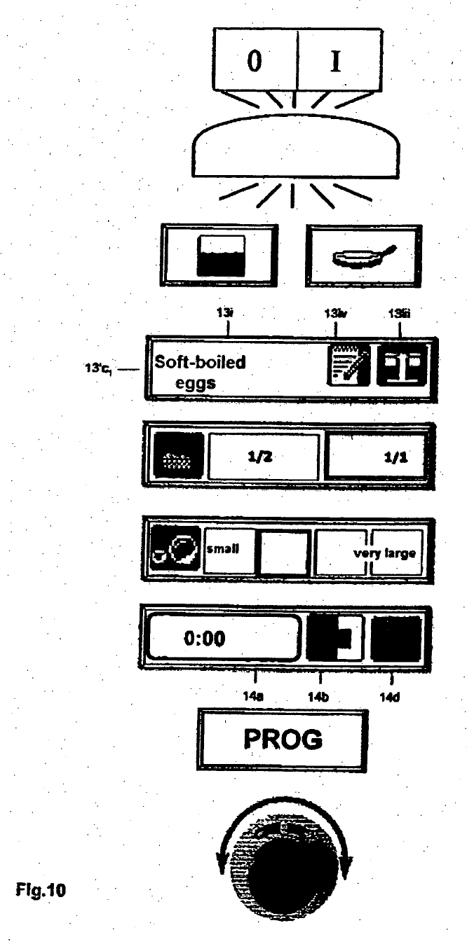

Directly after confirmation of the activated selection, as explained with reference to FIG. 3, the cooking method begins to proceed automatically. Hereby first water is poured into the left pan, namely, in the amount necessary for a full load of a cooking basket with relatively small eggs which are to be soft-boiled, as indicated in the area of information element 14a by droplets. In FIG. 4 the next cooking step can be seen, namely the heating of the water in the left pan, see the information text in the area of information element 14a. After the water reaches a temperature that is sufficient for the soft-boiling of relatively small eggs in a cooking basket which is fully loaded, the operator receives the request for the loading of the cooking basket with the said eggs, as can be seen in information element 14a in FIG. 5. As soon as the operator confirms via the selection and confirmation element 16 that the loading process has been completed, the cooking method continues automatically with the immersion of the cooking basket together with the eggs into the boiling water in the pan, as is shown with the aid of the egg timer in the information element 14a in FIG. 6. Next, in the area of information element 14a, the actual cooking time is indicated, for example three seconds in FIG. 7. After ending of the cooking time, which is sufficient for soft-boiling of relatively small eggs with which a cooking basket is completely loaded, the cooking basket is removed automatically from the boiling water, as is indicated by the egg timer in the region of information element 14a in FIG. 8. Finally, an operator receives the request via information element 14a to quench the cooked eggs, namely by spraying with a hand spray, see FIG. 9. As soon as an operator performs the request, he/she can communicate this to the cooking device via the selection and confirmation element 16. Then, still in the third menu level, on the display and operating device 1 in the region of the cooking product selection element 13c₁, instead of help text recall element 13ii, a cooking method storage element 13iv appears, and, when this is activated, the entire procedure can also be stored with reference to the cooking method described in FIGS. 1 to 10, for example under the program name “Eggs 1” in order to facilitate later repetition of this cooking method.

The cooking method according to the invention described with reference to the boiling of eggs naturally can be applied analogously to the cooking, for example, of rice in water or milk, to the boiling of pasta, especially noodles, in water, to the poaching of meat in stock or water or poaching of fish in a stock or water. Here the quenching step is omitted. Instead of loading a cooking basket, which is provided with a cover, not shown, for at least partial closing of the cooking pan used, the cooking product can also be placed directly on the cover, especially in the case of large pieces of meat or fish.

Reference list

| | |
|---|---|
| 1 | Display and operating device |
| 10 | On/off switch |
| 11 | Switching element for activating semi-automatic |
| | or fully automatic cooking method |
| 12 | Cooking operation type selection element |
| 12a | Switching element for activating the type of |
| | operation “boiling” or “poaching” |
| 12b | Switching element for activating the type of |
| | operation “roasting” |
| 12a + 12b | Switching element for activating the type of |
| | operation “frying” |
| 13 | Cooking product selection field |
| 13a-13f, 13c₁-13c₆ | Cooking product selection element |
| 13g | Cooking product charge selection element |
| 13h | Cooking product size selection element |
| 13i | Cooking product display |
| 13ii | Help text recall element |
| 13iii | Cooking device display |
| 13iv | Cooking method memory element |
| 14 | Communication element |
| 14a | Information element |
| 14b | Pan selection element |
| 14c | Help text recall element |
| 14d | Cancel element |
| 14e | Cooking time display |
| 15 | Programming element |
| 16 | Selection and confirmation element |

1.-12. (canceled)

13. Cooking method for a cooking device with at least one first cooking container which can be at least partially filled with a fluid cooking medium so that a cooking product can be cooked in the cooking medium, said method comprising the steps of:
(a) selecting semi-automatic cooking or fully automatic cooking by an operator;
(b) selecting at least one of a cooking product and a cooking process by an operator;
(c) automatically filling a first cooking container with a fluid cooking medium in an amount determined as a function of at least one of the selected cooking product and the selected cooking process;
(d) automatically heating the fluid cooking medium in the first cooking container to a temperature determined as a function of at least one of the selected cooking product and the selected cooking process;
(e) automatically introducing a cooking product into the heated cooking medium;
(f) automatically cooking the cooking product in the heated cooking medium as a function of at least one of the selected cooking product and the selected cooking process: and
(g) automatically removing the cooked cooking product from the cooking medium.

14. The cooking method of claim 13, wherein step (b) comprises selecting at least one of a type of cooking product, a cooking product charge, a cooking product size, a cooking product end condition, and a type of cooking operation through a display and operating device of the cooking device.

15. The cooking method of claim 14, comprising at least one of:
selecting a type of cooking product including at least one of eggs, vegetables, rice, pasta, and meat;
selecting a cooking product charge by selecting a load,
selecting a cooking product size by selecting a mean cooking product size,
selecting a cooking product end condition including selecting at least one of an internal cooking product end condition and of an external cooking product condition;
selecting a type of cooking operation by selecting at least one of boiling or poaching.

16. The cooking method of claim 15, comprising selecting said cooking product in a first menu level provided on the display and operating device.

17. The cooking method of claim 15, wherein the load is a second cooking container with a cooking product.

18. The cooking method of claim 17, wherein said second coating. container is a cooking basket.

19. The cooking method of claim 15, comprising selecting a cooking product charge in a second menu level provided on the display and operating device.

20. The cooking method of claim 15, comprising selecting a cooking product size in a second menu level provided on the display and operating device.

21. The cooking method of claim 15, comprising selecting an internal cooking product end condition determined by at least one of the cooking time and a core temperature of the cooking product provided in a second menu level provided on the display and operating device.

22. The cooking method of claim 15, comprising selecting an external cooking product condition provided in a second menu level provided on the display and operating device.

23. The cooking method of claim 15, comprising selecting a type of cooking operation in a second menu level provided on the display and operating device.

24. The cooking method of claim 13, comprising the step of:
(h) automatically requesting loading of a movable part of the cooking device which can be moved relative to the first cooking container with the cooking product by the display and operating device of the cooking device.

25. The cooking method of claim 24, comprising carrying out step (h) after reaching a predetermined temperature on the cooking medium.

26. The cooking method of claim 24, comprising the step of:
(i) automatically requesting unloading the movable part of the cooking device from the cooking product, via the display and operating device of the cooking device.

27. The cooking method of claim 26, wherein the cooking product comprises eggs, the method comprising the sequential steps of automatically requesting quenching the removed eggs, and automatically requesting unloading the quenched eggs.

28. The cooking method of claim 26, comprising carrying out step (i) after the elapse of a predetermined cooking time determined as a function of at least one of the selected cooking product and selected cooking process and/or after reaching a predetermined core temperature in the cooking product determined as a function of the selected cooking product and/or the selected cooking process.

29. The cooking method of claim 24, comprising moving the movable part of the cooking device automatically for intermittent introduction of the cooking product into the heated cooking medium.

30. The cooking method of claim 29, wherein the movable part of the cooking device is in working connection with a cover of the first cooking container, with which the first cooking container can be at least partially closed.

31. The cooking method of claim 30, comprising moving at least one second cooking container, which can be loaded with cooking product and connected to the cover, into and out of the first cooking container.

32. The cooking method of claim 24, wherein each automatic request in at least one third menu level of the display and operating device.

33. The cooking method of claim 14, wherein the display and operating device comprises at least one touch screen, in interaction with a control or regulation device of the cooking device.

34. The cooking method of claim 33, wherein the touch screen provides a menu level as a function of at least one selection step carried out by an operator for offering at least one request and/or for providing at least one item of information about the status of the cooking method as well as for receiving at least one command in at least one selection step for guiding the cooking method.

35. The cooking method of claim 13, wherein the method can be stored and/or programmed, through the display and operating device.

36. The cooking method of claim 35, comprising storing and/or programming the method through the display and operating device

37. The cooking method of claim 35, comprising and/or programming the method after automatically removing the cooked cooking product from the cooking medium.

38. The cooking method of claim 13, comprising interrupting and/or explaining the method with the aid of a help text.
